(19) United States
(12) Patent Application Publication
(10) Pub. No.: US 2025/0060644 A1
(43) Pub. Date: Feb. 20, 2025

(54) MULTI-CHANNEL CONTROL SYSTEM FOR CONTROLLING PLURALITY OF SMART WINDOWS

(71) Applicant: GOOIL SOLUTION CO., LTD., Gyeongsangbuk-do (KR)

(72) Inventors: Jae Yeol LEE, Daegu (KR); Ho Cheol SHIN, Daegu (KR)

(73) Assignee: GOOIL SOLUTION CO., LTD, Gyeongsangbuk-do (KR)

(21) Appl. No.: 18/935,391

(22) Filed: Nov. 1, 2024

Related U.S. Application Data
(63) Continuation of application No. PCT/KR2023/005711, filed on Apr. 26, 2023.

(30) Foreign Application Priority Data
Jun. 22, 2022 (KR) 10-2022-0076056

(51) Int. Cl. G02F 1/153

(52) U.S. Cl. CPC G02F 1/153

(57) ABSTRACT

A multi-channel control system for controlling a plurality of smart windows by using multiple channels. A unit control module for controlling tinting of multiple smart windows includes a communication means configured to receive control data for controlling tinting of the smart windows from a wireless router or a main control module connected to an external control server for communication, multiple communication channel transmitters configured to provide information on voltage application time points at which voltages are applied to control tinting of the smart windows, voltage application end points at which voltage application is interrupted, and time points at which the voltages of the smart windows are measured, multiple communication channel transmitter being respectively connected to the smart windows that require tinting control, and a controller configured to perform control such that the information provided by multiple communication channel transmitters is provided at different times.

### CROSS-REFERENCE TO RELATED APPLICATIONS

This is a continuation application of PCT international application PCT/KR2023/005711 filed on Apr. 26, 2023, which claims priority based on Korean Patent Application No. 10-2022-0076056 filed on Jun. 22, 2022, which are incorporated herein by reference in their entirety.

### TECHNICAL FIELD

The present disclosure relates to a multi-channel control system for controlling smart windows. More particularly, the present disclosure relates to a multi-channel control system for controlling tinting of a plurality of smart windows by using multiple channels.

### BACKGROUND

In general, the glass industry has recently sought to produce higher-quality materials by changing the characteristics of existing glass on the basis of energy saving effects and the use of eco-friendly materials. In addition, the need to produce glass that can artificially control the transmittance of visible light has emerged, and new glass material called a smart window is attracting attention.

A smart window is a glass window that changes the permeability for light depending on the magnitude of voltage. That is, when the outdoor temperature increases, the permeability of the glass window decreases to block radiation caused by solar radiation. When the outdoor temperature decreases, the permeability of the glass window increases to allow solar radiation to enter the room, which increases the indoor temperature due to solar radiation.

The smart windows are eco-friendly and enable efficient energy use by reducing cooling and heating loads. In addition, the smart windows also improve the quality of life for users by creating safe and comfortable residential and urban environments. In addition, in buildings as well as in industry (information signs, and product displays), and transport (sunroofs), the smart windows are a functional alternative with a wide range of applications.

In developed areas such as the United States, Japan, and Europe, smart windows are attracting attention as the next generation of high-functional and high-value-added products, and product development research using smart materials has been widely conducted for use in energy-saving intelligent buildings, windows for various types of transport, and large display elements. Products are being developed in areas such as interior partitions using liquid crystal materials and automotive mirrors using electrochromic glass. In addition, basic research on films using liquid crystals among various materials is underway in Korea, and research has been conducted at institutions including research institutes.

### BRIEF SUMMARY

The present disclosure is directed to providing a multi-channel control system for controlling tinting of a plurality of smart windows.

In addition, the present disclosure is directed to providing a multi-channel control system for controlling tinting of a plurality of smart windows by using wireless communication.

In addition, the present disclosure is directed to providing a multi-channel control system for controlling tinting of a plurality of smart windows by using time division communication.

### Technical Solution

To this end, the present disclosure provides a unit control module for controlling tinting of at least two smart windows, the unit control module including: a communication transceiver configured to receive control data for controlling tinting of the smart windows from a wireless router or a main control module connected to an external control server for communication; at least two communication channel transmitters configured to provide information on voltage application time points at which voltages are applied to control tinting of the smart windows, voltage application end points at which voltage application is interrupted, and time points at which the voltages of the smart windows are measured, the at least two communication channel transmitters being respectively connected to the smart windows that require tinting control; and a controller configured to perform control such that the information provided by the at least two communication channel transmitter is provided at different times.

According to the present disclosure, a multi-channel control system for controlling a plurality of smart windows uses one unit to control tinting of the plurality of smart windows, and controls the smart windows by wireless, thereby realizing ease of installation.

In addition, according to the present disclosure, tinting of a plurality of smart windows is controlled using time division communication, so smart windows of which tinting is controlled can be easily added by adjusting the divided time.

### BRIEF DESCRIPTION OF DRAWINGS

FIG. 1 shows a multi-channel control system for controlling smart windows according to an embodiment of the present disclosure.

FIG. 2 shows a multi-channel control system for controlling smart windows according to another embodiment of the present disclosure.

FIG. 3 shows a multi-channel control system for controlling smart windows according to still another embodiment of the present disclosure.

FIG. 4 shows a unit control module for controlling smart windows according to an embodiment of the present disclosure.

FIG. 5 is a flowchart showing the operation performed by a unit control module according to an embodiment of the present disclosure.

FIG. 6 shows a configuration for measuring the voltage of a smart window by a controller according to an embodiment of the present disclosure.

FIG. 7 shows a procedure in which a main control module performs communication with a plurality of unit control modules in a time division manner according to an embodiment of the present disclosure.

FIG. 8 shows a network for controlling smart windows by using multiple channels according to an embodiment of the present disclosure.

### DETAILED DESCRIPTIONS

The aforementioned and additional aspects of the present disclosure will be more apparent through an exemplary embodiment described with reference to the accompanying drawings. Hereinafter, the embodiment of the present disclosure will be described in detail so that those skilled in the art can easily understand and reproduce the embodiment.

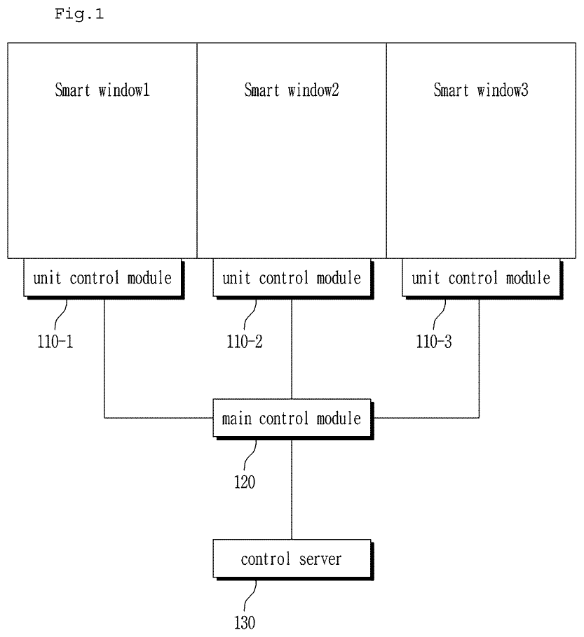

FIG. 1 shows a multi-channel control system for controlling smart windows according to an embodiment of the present disclosure. Hereinafter, a multi-channel control system for controlling smart windows according to an embodiment of the present disclosure will be described in detail with reference to FIG. 1.

According to FIG. 1, the multi-channel control system for controlling smart windows includes a control server, a main control module, unit control modules, and sensors. Other configurations besides the aforementioned configuration may be included the multi-channel control system for smart windows, proposed in the present disclosure.

According to FIG. 1, unit control modules 110-1 to 110-3 are formed for each smart window, and a plurality of unit control modules 110-1 to 110-3 located in a particular direction are connected to a main control module 120. The main control module 120 is connected to an internal illuminance sensor, an external illuminance sensor, an internal temperature sensor, and an external temperature sensor, and receives illuminance and temperature measured by the respective sensors.

The unit control modules 110-1 to 110-3 control the magnitudes of currents supplied to the respective smart windows according to control data of the main control module 120. The unit control modules 110-1 to 110-3 supply voltages (currents) having different magnitudes to the respective smart windows according to the characteristics of each of the smart windows received from the main control module 120, and the smart windows are tinted by the supplied voltages.

The control server 130 is connected to the main control module 120, and sets the voltages supplied to the smart windows. That is, depending on the magnitudes of voltages supplied to the smart windows, the smart windows are tinted. Regarding the present disclosure, while the control server 130 sets the voltages supplied to the smart windows to be supplied as the voltages according to a mode set, the unit control modules 110-1 to 110-3 finely adjust the voltages set by the control server 130 according to the characteristics of each of the smart windows received from the main control module and supply the adjusted voltages. That is, the unit control modules 110-1 to 110-3 perform control such that finely adjusted voltages are provided to the smart windows. To elaborate, the unit control modules 210 perform control such that the voltages supplied to the respective smart windows are supplied in a finely adjusted state so as to prevent color differences from occurring according to the unique characteristics of each of the smart windows.

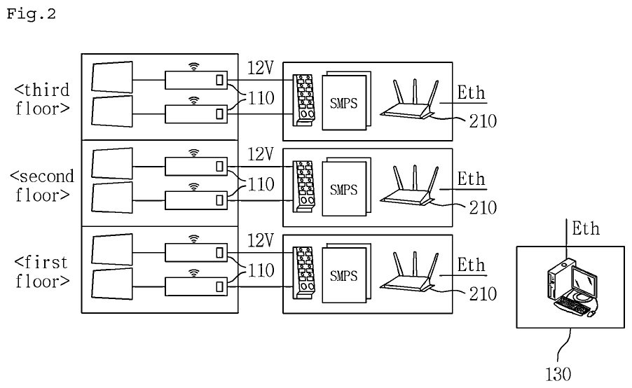

FIG. 2 shows a multi-channel control system for controlling smart windows according to another embodiment of the present disclosure. Hereinafter, a multi-channel control system for controlling smart windows according to another embodiment of the present disclosure will be described in detail with reference to FIG. 2.

According to FIG. 2, the multi-channel control system for smart windows includes a control server 130, wireless routers 210, unit control modules 110, and sensors (not shown). Other configurations besides the aforementioned configuration may be included the multi-channel control system for smart windows, proposed in the present disclosure.

In particular, FIG. 2 shows the case in which data is transmitted and received in a wireless manner in a particular section. According to FIG. 2, the multi-channel control system proposes the wireless routers 210, and uses the wireless routers 210 to transmit control data received from the control server 130 to the unit control modules 110. In particular, it can be seen that FIG. 2 excludes the main control unit, unlike FIG. 1.

The unit control modules 110-1 to 110-3 supply voltages (currents) having different magnitudes to the respective smart windows according to the received characteristics of each of the smart windows. FIG. 2 shows that wireless communication is performed between the wireless routers 210 and the unit control modules 110-1 to 110-3, but no limitation thereto is imposed. The wireless routers 210 and the unit control modules 110-1 to 110-3 may transmit and receive control data also through wired communication.

The sensors include an internal illuminance sensor, an external illuminance sensor, an internal temperature sensor, and an external temperature sensor. Information collected by the sensors is provided to the unit control modules or the main control module.

In addition, the control system may include SMPSs and terminals. That is, the terminals are connected to the unit control modules, and the SMPSs control the voltages supplied to the unit control modules through the terminals. Indeed, a unit control module controls one smart window.

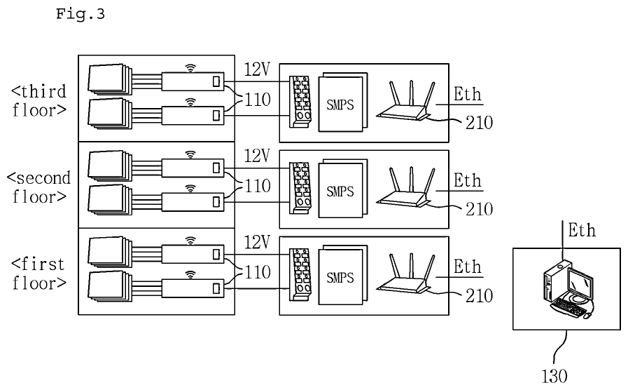

FIG. 3 shows a multi-channel control system for controlling smart windows according to still another embodiment of the present disclosure. Hereinafter, a multi-channel control system for controlling smart windows according to another embodiment of the present disclosure will be described in detail with reference to FIG. 3.

According to FIG. 3, the multi-channel control system for smart windows includes a control server, wireless routers, unit control modules, and sensors (not shown). Other configurations besides the aforementioned configuration may be included the multi-channel control system for smart windows, proposed in the present disclosure.

In particular, FIG. 2 shows the case in which control data is transmitted or received in a wireless manner in a particular section. According to FIG. 3, the multi-channel control system proposes the wireless routers 210, and uses the wireless routers 210 to transmit control data received from the control server 130 to the unit control modules. In particular, it can be seen that FIG. 3 excludes the main control unit, unlike FIG. 1, and one of unit control modules 110-1 to 110-3 controls tinting of a plurality of smart windows.

The unit control modules 110-1 to 110-3 supply voltages (currents) having different magnitudes to the respective smart windows according to the received characteristics of each of the smart windows. FIG. 3 shows that wireless communication is performed between the wireless routers and the unit control modules, but no limitation thereto is imposed. The wireless routers and the unit control modules may transmit and receive control data also through wired communication.

The sensors include an internal illuminance sensor, an external illuminance sensor, an internal temperature sensor, and an external temperature sensor. Information collected by the sensors is provided to the unit control modules or the main control module.

In addition, the control system may include SMPSs and terminals. That is, the terminals are connected to the unit control modules, and the SMPSs control the voltages supplied to the unit control modules through the terminals.

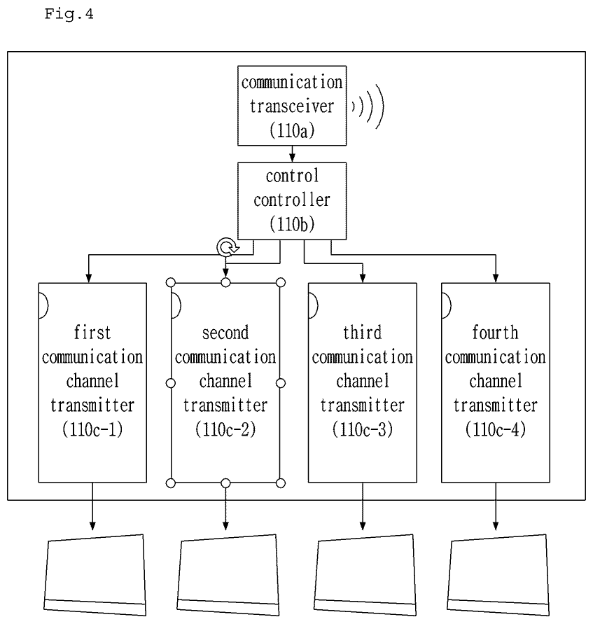

FIG. 4 shows the unit control module for controlling smart windows according to an embodiment of the present disclosure. Hereinafter, the unit control module according to an embodiment of the present disclosure will be described with reference to FIG. 4.

In particular, FIG. 4 shows the configuration for controlling tinting of a plurality of smart windows by the unit control module, and the unit control module uses a plurality of channels to control tinting of the smart windows.

According to FIG. 4, the unit control module includes a communication transceiver 110a, a controller (such as a CPU) 110b, and a plurality of communication channel transmitter 110c-1 to 110c-4. The communication transceiver 110a includes a wireless communication transceiver (transmitter and/or receiver) or a wired communication transceiver, and receives control data for smart window tinting from the outside. The communication transceiver provides the received control data to the controller.

The controller 110b controls tinting of the smart windows by using the communication channel transmitters 110c-1 to 110c-4 that perform communication with the smart windows according to the received control data. In addition, according to the present disclosure, the communication channel transmitters 110c-1 to 110c-4 are formed for each of the smart windows, and the controller 110b controls tinting of the smart windows using a time division communication method. For example, tinting of a first smart window is controlled using a first communication channel transmitter for a first time period, tinting of a second smart window is controlled using a second communication channel transmitter for a second time period, tinting of a third smart window is controlled using a third communication channel transmitter for a third time period, and tinting of a fourth smart window is controlled using a fourth communication channel transmitter for a fourth time period.

As described above, the unit control module performs communication with the plurality of smart windows in a time division manner to control tinting of the smart windows.

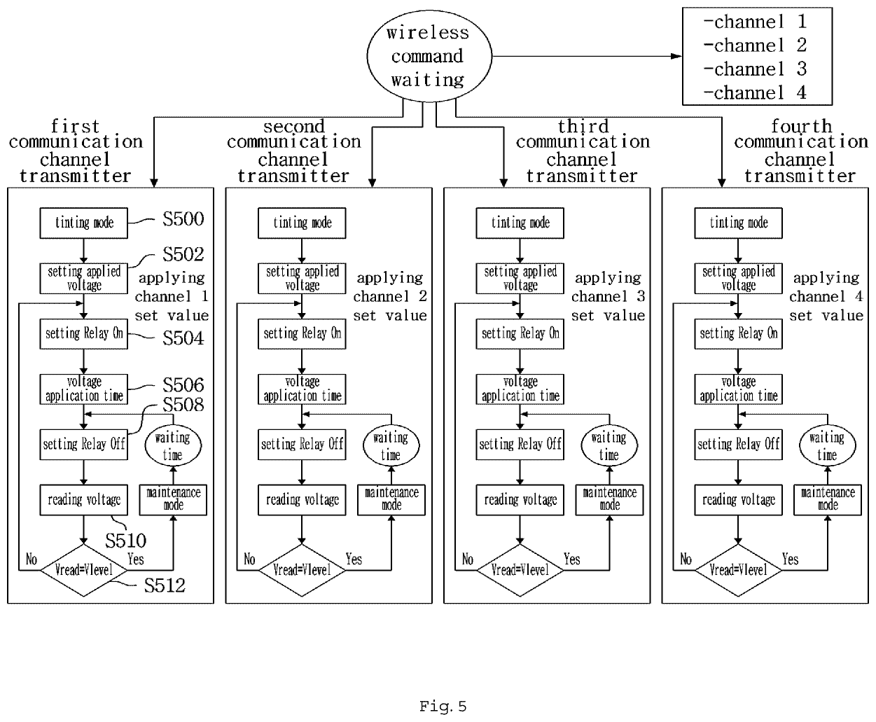

FIG. 5 is a flowchart showing the operation performed by the unit control module according to an embodiment of the present disclosure. Hereinafter, the operation performed by the unit control module according to an embodiment of the present disclosure will be described with reference to FIG. 5.

In FIG. 5, the unit control module performs communication with four smart windows, in particular, and thus uses four channels to perform communication with a plurality of smart windows, respectively. That is, the unit control module manages the four channels through time division communication by using a plurality of communication channel transmitters. Hereinafter, the operation performed by the controller of the unit control module will be described.

The controller performs communication with the smart windows by using a first communication channel transmitter to a fourth communication channel transmitter. Hereinafter, a process of controlling tinting of a first smart window by using the first communication channel transmitter will be described.

In step S500, the controller enters a tinting mode of the smart window.

In step S502, the controller sets the voltage to be applied to the first smart window to control tinting of the first smart window.

In step S504, the controller controls the first communication channel transmitter to apply a set applied voltage.

In step S506, voltage application time is reached, and in step S508, the controller interrupts voltage application.

In step S510, the controller performs control such that the voltage applied for tinting of the smart window is measured.

In step S512, the controller compares the voltage measured in step S510 and the voltage set in step S502, and when the measured voltage is the same as the set voltage or within a set range, the controller enters a maintenance mode and then waits for a particular time period. Indeed, after waiting for the particular time period, the controller measures the voltage applied for tinting of the smart window.

When the measured voltage is lower than the set range of the set voltage, the controller goes to step S504 for increase up to the set voltage for tinting of the smart window.

In this way, the controller uses the first communication channel transmitter to control tinting of the first smart window, and also uses the second communication channel transmitter to the fourth communication channel transmitter to control tinting of the second smart window to the fourth smart window.

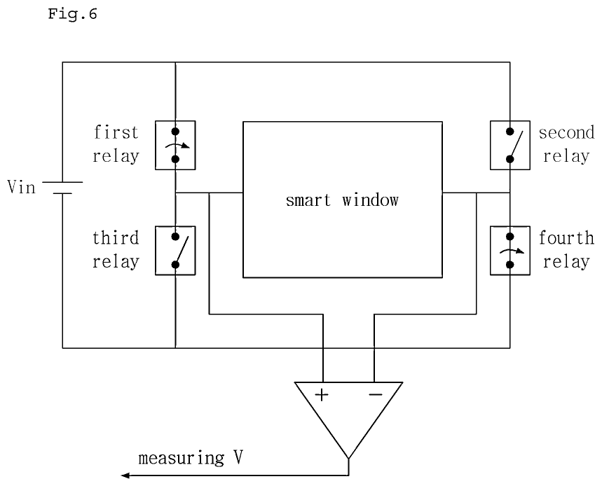

FIG. 6 shows a configuration for measuring the voltage of a smart window by a controller according to an embodiment of the present disclosure. Hereinafter, the configuration for measuring the voltage of a smart window will be described with reference to FIG. 6.

According to FIG. 6, the configuration for measuring the voltage of the smart window includes a plurality of relays and an OP Amp. A first relay and a second relay are connected in series, and a third relay and a fourth relay are also connected in series.

The first relay and the second relay, which are connected in series, are connected in parallel with the third relay and the fourth relay, which are connected in series.

Voltage application is supplied to the first relay and the third relay, and the voltage is supplied from the connection point of the first relay and the second relay to a first side of the smart window, and the voltage is supplied from the connection point of the third relay and the fourth relay to a second side of the smart window.

When the smart window is charged with voltage, the first relay and the fourth relay are turned on and the second relay and the third relay are turned off. When the voltage of the smart window is discharged, the second relay and the third relay are turned on and the first relay and the fourth relay are turned off.

When it is desired to measure the voltage of the smart window, the voltage is measured using the OP Amp differential amplifier while the first relay to the fourth relay are turned off.

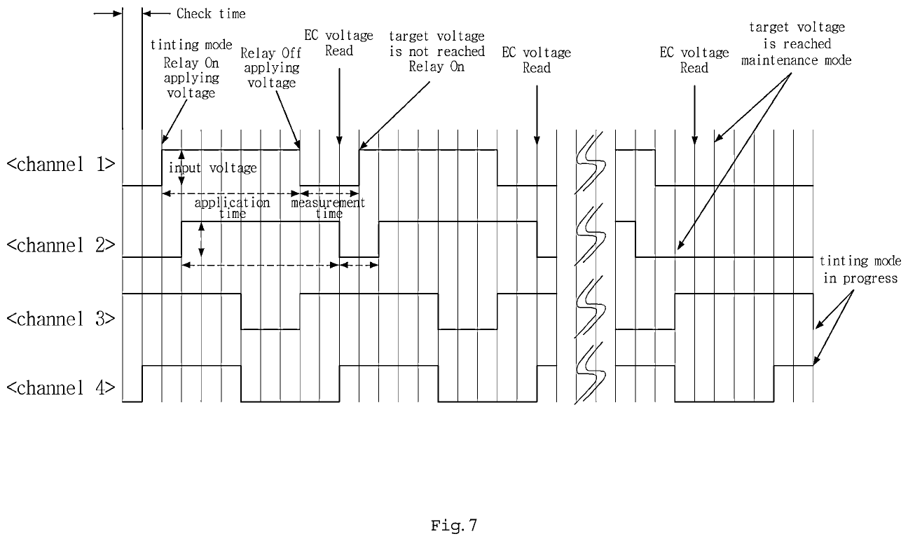

FIG. 7 shows a procedure in which a controller uses communication channel transmitter to perform communication with a plurality of smart windows in a time division manner according to an embodiment of the present disclosure. Hereinafter, a procedure in which a controller uses a communication channel transmitter to perform communication with a plurality of smart windows in a time division manner according to an embodiment of the present disclosure will be described with reference to FIG. 7.

As described above, channels have different application times during which voltage is applied and have different input voltages, and also take different times to reach set voltages set according to characteristics of the smart windows.

According to FIG. 7, a first channel to a fourth channel adjust a voltage application request time point, a voltage interruption request time point, and a voltage measurement time point in a time division manner. In addition, according to the present disclosure, when a measured voltage is equal to a set voltage, a maintenance mode is entered for a particular time period and tinting of the smart window is maintained.

Regarding the present disclosure, the interval between a voltage application request time point and a voltage interruption request time point varies according to the characteristics of a smart window. According to the size of the smart window, the amount and composition of electrolyte injected into a smart window film, the characteristics of a process for producing the smart window, and high-speed tinting or low-speed tinting, the interval between a voltage application request time point and a voltage interruption request time point varies.

Other cases in which a relatively short time between a voltage application request time point and a voltage interruption request time point is required include a case in which the electrolyte composition is aged due to prolonged use, a case in which there are many tinting stages (to prevent the voltage levels of the stages from interfering with each other), a case in which there is strong illuminance, a case in which there is a large transmittance change, or a case in which a relatively high voltage is applied (to protect a tinting film).

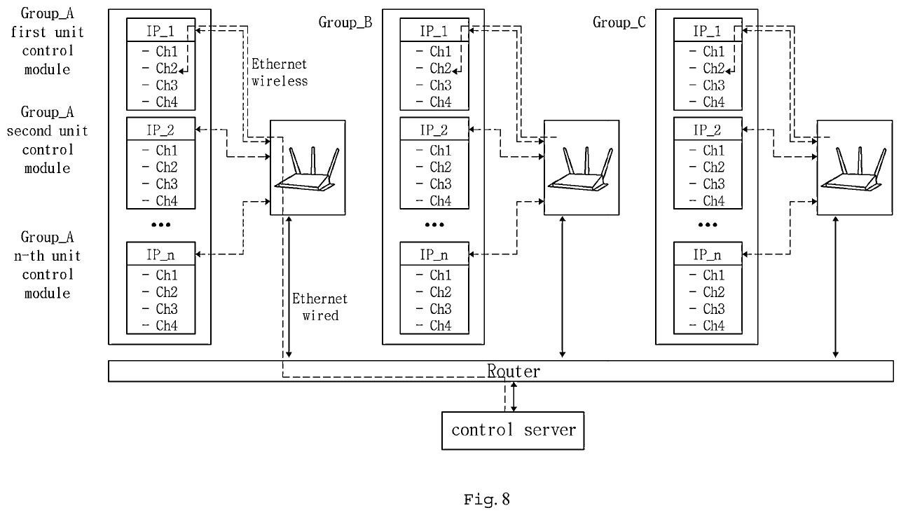

FIG. 8 shows a network for controlling smart windows by using multiple channels according to an embodiment of the present disclosure. Hereinafter, a process of controlling smart windows by using multiple channels will be described with reference to FIG. 8.

According to FIG. 8, the network for controlling smart windows includes a control server and wireless routers. Indeed, other configurations besides the aforementioned configuration may be included in the network for controlling smart windows, proposed in the present disclosure.

The control server is connected to the wireless routers via a router. The control server is connected to the wireless routers in a wired manner, and the wireless routers are connected to the unit control modules in a wireless manner.

A wireless router is connected to a plurality of unit control modules in a wireless manner. In FIG. 8, one wireless router is connected to a first unit control module (IP_1) to a n-th unit control module (IP-n) in a wireless manner. A unit control module uses a first channel to a fourth channel to control tinting of four smart windows. Indeed, depending on the number of channels of a unit control module, the number of smart windows of which tinting is controlled also varies.

A command path to control tinting of a smart window in the control server includes unique identification information and channel identification information of a wireless router, such as ‘Send (Group_A+IP_1, Protocol_Ch2)’.

The present disclosure has been described with reference to an exemplary embodiment illustrated in the drawings for illustrative purpose, and those skilled in the art will understand that the present disclosure may be modified in various ways and that other equivalent embodiments are possible.

The present disclosure relates to a multi-channel control system for controlling smart windows. More particularly, the present disclosure relates to a multi-channel control system for controlling tinting of a plurality of smart windows by using multiple channels.

According to the present disclosure, a multi-channel control system for controlling a plurality of smart windows uses one unit to control tinting of the plurality of smart windows, and controls the smart windows by wireless, thereby realizing ease of installation.

In addition, according to the present disclosure, tinting of a plurality of smart windows is controlled using time division communication, so smart windows of which tinting is controlled can be easily added by adjusting the divided time.

1. A smart window control device for controlling tinting of at least two smart windows, the unit control module comprising:
a communication transceiver configured to receive control data for controlling tinting of the smart windows from a wireless router or a main control module connected to an external control server for communication;
at least two communication channel transmitters configured to provide information on voltage application time points at which voltages are applied to control tinting of the smart windows, voltage application end points at which voltage application is interrupted, and time points at which the voltages of the smart windows are measured, the at least two communication channel transmitters being respectively connected to the smart windows that require tinting control; and
a controller configured to perform control such that the information provided by the at least two communication channel transmitters is provided at different times.

2. The smart control device of claim 1, wherein the controller is configured to provide, when a set voltage that is the control data for tinting of the smart window is received through the communication means, the voltage application time point and the voltage application end point sequentially to the communication channel transmitter, and
make, after providing the voltage application end point, a request for measuring and providing the voltage of the smart window.

3. The unit control module of claim 2, wherein the controller is configured to provide, when the measured voltage of the smart window received from the communication channel transmitter is lower than the set voltage, the voltage application time point and the voltage application end point sequentially to the communication channel transmitter.

4. The unit control module of claim 2, wherein the voltage of the smart window is measured using
a first relay and a third relay formed at a first side of the smart window;
a second relay and a fourth relay formed at a second side of the smart window; and
an OP amp to which the first side and the second side of the smart window are connected as inputs.

5. The unit control module of claim 4, wherein when the smart window is charged with the voltage, the first relay and the fourth relay are turned on and the second relay and the third relay are turned off, or
when the voltage of the smart window is discharged, the first relay and the fourth relay are turned off and the second relay and the third relay are turned on, or
when the voltage of the smart window is measured, the first relay to the fourth relay are turned off.

6. The unit control module of claim 2, wherein the controller is configured to relatively shorten time between the voltage application time point and the voltage application end point when an electrolyte component of the smart window is aged, when there are relatively many tinting stages, when there is strong illuminance, when a transmittance change of the smart window is relatively large, or when a relatively high voltage is applied.

7. A multi-channel smart window tinting system, comprising:
a unit control module of claim 1;
at least two smart windows connected to at least two communication channel transmitter of the unit control module; and
a control server configured to transmit control data for tinting of the smart windows to the unit control module.

8. The multi-channel smart window tinting system of claim 7, further comprises an internal illuminance sensor, an external illuminance sensor, an internal temperature sensor, and an external temperature sensor, and illuminance and temperature measured by the respective sensors are provided to the unit control module.

9. The multi-channel smart window tinting system of claim 8, wherein
the internal illuminance sensor is configured to measure internal illuminance of the smart window,
the external illuminance sensor is configured to measure external illuminance of the smart window,
the internal temperature sensor is configured to measure internal temperature of the smart window, and
the external temperature sensor is configured to measure external temperature of the smart window.
